(19) United States
(12) Patent Application Publication
(10) Pub. No.: US 2005/0003056 A1
(43) Pub. Date: Jan. 6, 2005

(54) Article of commerce comprising edible substrate, image, and message

(75) Inventors: Benito Alberto Romanach, Mason, OH (US); Lufang Wen, Mason, OH (US); Yen-Ping Chin Hsieh, Cincinnati, OH (US); John Humbert Baer, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/880,726

(22) Filed: Jun. 30, 2004

Related U.S. Application Data
(60) Provisional application No. 60/484,449, filed on Jul. 2, 2003.
(60) Provisional application No. 60/486,312, filed on Jul. 11, 2003.

(51) Int. Cl. A23P 1/00

(52) U.S. Cl. 426/383

(57) ABSTRACT

An article of commerce comprising an edible substrate having an image disposed thereon. The article further has a message associated with the image, wherein the message links the image to an interactive component. Optionally the article comprises a container which contains the edible substrate.

### CROSS REFERENCE TO RELATED APPLICATIONS

This application claims the benefit of priority to U.S. Provisional Application Ser. No. 60/484,449, filed Jul. 2, 2003, and to U.S. Provisional Application Ser. No. 60/486,312, filed Jul. 11, 2003, both of which are herein incorporated by reference.

### FIELD OF INVENTION

The present invention relates to articles of commerce comprising edible substrates, and more particularly to edible substrates having an image disposed thereon

### BACKGROUND OF THE INVENTION

Food provides more than just physical sustenance. Food also provides enjoyment through means such as visual appeal. Many popular food items, such as cookies, cakes, and candies, comprise some sort of decoration that makes the food item more visually appealing. The value that such decoration provides to the consumer, however, is limited by the visual aesthetics of the decoration. This leads to an increased reliance on the decorative aspects of the decoration itself to engage the consumer and encourage the consumer to enjoy the food item.

Accordingly, it would be desirable to provide a food item comprising an image which provides more than just aesthetic value. It would be especially desirable to provide such a food item wherein the value of the image is not dependent upon aesthetics alone. It would also be desirable for the food item to provide enhanced value to the consumer; e.g., through interaction with a consumer.

### SUMMARY OF THE INVENTION

The present invention provides an article of commerce comprising an edible substrate having an image which provides value beyond the aesthetic value of the image. As a result, the edible substrate provides enhanced value to the consumer.

In one aspect, the present invention provides an article of commerce comprising:
(a) an edible substrate;
(b) an image disposed upon said edible substrate;
(c) a message associated with said image, wherein said message links the image to an interactive component; and
(d) optionally a container for containing said edible substrate.
   In a preferred embodiment, the edible substrate comprises a fabricated snack chip.

The value of the image is enhanced and sustained by creating a connection between the image and the interactive component via the message. Such connection leads in turn to a sustained level of consumer engagement and stimulation, increased product desirability, and also serves to build a stronger relationship between the article manufacturer and the consumer.

All documents cited herein are, in relevant part, incorporated herein by reference; the citation of any document is not to be construed as an admission that it is prior art with respect to the present invention.

### BRIEF DESCRIPTION OF THE DRAWINGS

FIG. 1 represents an embodiment of Example 4. Images disposed on fabricated potato crisps are portions of a larger image that can be provided as an interactive component.

FIG. 2 represents an embodiment of Example 7. The image provides a tip to better perform when playing a video game.

FIG. 3 represents an embodiment of Example 8. The image provides an instruction to be used while playing a game.

FIG. 4 represents an embodiment of Example 9. The image is a graphic that can be viewed as a 3-dimensional object when viewed through 3-D glasses. In this example, the image of a car is printed twice on the chip, showing the left and the right eye views of the car, to produce the 3-dimensional effect.

FIG. 5 represents an embodiment of Example 10. The image disposed on the chip is a cryptogram comprising five symbols. A container that contains the chip comprises a label having a key for decoding the cryptogram. A message is printed above the key on the container and instructs the consumer to use the key to decode the cryptogram.

FIG. 6 depicts a fabricated snack chip (edible substrate) having an image of an incomplete house disposed thereon, and a package insert (interactive component) having a pictorial representation of the complete house. A message on the package that contains the edible substrate directs the consumer to guess what the object (the house) is and to refer to the package insert (interactive component) for the answer.

### DETAILED DESCRIPTION OF THE INVENTION

The present invention provides an article of commerce comprising:
(a) an edible substrate;
(b) an image disposed upon said edible substrate;
(c) a message associated with said image, wherein said message links the image to an interactive component; and
(d) optionally a container for containing said edible substrate.
   A. Edible Substrate

As used herein, “edible substrate” or “substrate” includes any material suitable for consumption that is capable of having an image disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, cakes, chewing gum, candy, bread, fruit, dried fruit, beef jerky, crackers, pasta, hot dogs, sliced meats, cheese, pancakes, waffles, dried fruit film, breakfast cereals, toaster pastries, ice cream cones, ice cream, gelatin, ice cream sandwiches, ice pops, yogurt, desserts, cheese cake, pies, cup cakes, English muffins, pizza, pies, meat patties, and fish sticks.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., gelatin, yogurt).

In addition, the edible substrate can include pet foods such as, but not limited to, dog biscuits and dog treats.

The article of commerce can comprise one or a plurality of edible substrates.

In a preferred embodiment, the substrate is a fried fabricated snack chip. The image can be disposed upon the snack chip by any suitable means. For instance, the image can be disposed on the chip dough before the dough is fried to make the fried fabricated snack chip, or the image can be disposed on the chip after it has been fried.

In one embodiment, the fabricated snack chip is a potato-based fabricated snack crisp, such as that described by Lodge in U.S. Pat. No. 5,464,643, and Villagran et al. in U.S. Pat. No. 6,066,353.

B. Image Disposed Upon Said Edible Substrate

The edible substrate comprises an image disposed thereon. The image can comprise one or more text, graphic, or combinations thereof. As used herein, “text” means one or more alpha-numeric symbols. Text can include letters, numbers, words, and combinations thereof. As used herein, “graphic” means pictorial representation.

For instance, the graphic can include objects, symbols, scenes, people, animals, toys, or characters. Suitable characters can include cartoon characters and licensed characters, as well as characters associated with popular personalities in the media, advertising, or well known in the particular culture.

As used herein, “disposed on” means that one element can be integral with another element, or that one element can be a separate structure bonded to or placed on another element. Thus, the image can be applied directly or indirectly to the edible substrate, applied to a material that is placed on the edible substrate, applied within the edible substrate, or other variations or combinations thereof. In particular embodiments, the image can be printed, sprayed, or other wise applied directly on the surface of the substrate. In other embodiments, the image can be applied to a material placed on the surface of the substrate. The image can be located on the outer surface of the substrate, or can be located on the interior of the substrate, or combinations thereof.

Any suitable means of disposing an image on the substrate can be used herein. For example, the image can be printed, drawn, painted, or otherwise attached to the edible substrate. The image can be single-color or multi-color. The image can comprise dyes, pigments, other natural or synthetic substances, or combinations thereof.

In one embodiment, the image is printed on the substrate. Methods of printing can include, but are not limited to, laser, ink jet (e.g., thermal bubble jet, piezoelectric drop on demand, continuous ink jet), gravure, flexographic, and stamping.

In another embodiment, an edible sticker comprising an image is affixed to the substrate.

In another embodiment, a thin film comprising an image is affixed to the substrate via edible adhesive.

In a preferred embodiment, an ink jet image is printed on a fabricated snack chip.

In another embodiment, an image formed from edible ink is disposed upon the surface of a serving of yogurt.

Any suitable image can be used. The image can comprise one or more graphic elements, one or more text elements, or combinations thereof. Non-limiting examples include letters, numbers, words, animals, cartoon characters, popular figures from the media, caricatures, historic events, and photographs.

Furthermore, images can be in the form of full or partial words, numbers, clues, hints, jokes, revelations, trivia quizzes, photographs, pictures, puzzles, stories, games, or sequence of events (e.g. animations). For example, the image can comprise the question portion of a trivia quiz. In one embodiment, the image depicts a piece of a jig-saw puzzle.

The image can cover part or all of the visual portion of the edible substrate. In addition, the image can include one or more images disposed upon said edible substrate.

Furthermore, the image can be permanent or active. Permanent images include those that do not change before consumption of the edible substrate. Active images include those that can be modified by some means before consumption of the edible substrate.

For example, active images include those that can be visually modified. In one embodiment, an invisible image becomes visible when the substrate comes into contact with saliva (e.g., the substrate is licked). In another embodiment, the image becomes visible when the substrate is held under a black light source. In yet another embodiment, the visible image becomes invisible when the substrate comes into contact with saliva. In still another embodiment, the visible image disappears and a second, different, image appears when the substrate comes into contact with saliva.

In one embodiment, a container comprises a plurality of edible substrates, wherein more than one edible substrate in said container comprises the same image. (e.g., at least two the same)

In another embodiment, a container comprises a plurality of edible substrates, wherein at least one edible substrate comprises an image. (e.g., at least one printed potato crisp in a container)

In another embodiment, a container comprises a plurality of edible substrates, wherein at least two edible substrates have images disposed thereon. At least two of the edible substrates have images that are different from one another.

### A PREFERRED EMBODIMENT

In a preferred embodiment, the article of commerce comprises:
(a) a container;
(b) a plurality of edible substrates contained within said container, where the number of said edible substrates contained within said container is equal to n; and
(c) from 1 to n images, wherein the number of different images is from 1 to n, and wherein said images are disposed upon from I to n of said edible substrates.
(d) a message associated with at least I to n of said images, wherein said message links at least 1 to n of said images to an interactive component.

In one embodiment, one or more images can be multi-colored. In another embodiment, all the images in the container are different (the number of different images=n). In yet another embodiment, the article comprises at least 10 edible substrates, wherein the number of different images=at least 10.

In still another embodiment, the number of different images=the number of edible substrates which comprise one serving of said edible substrate.

C. A Message Associated with Said Image, Wherein Said Message Links the Image to an Interactive Component

The article of commerce further comprises a message associated with the image, wherein the message links the image to an interactive component. As used herein, “interactive component” includes any tactile, audio, visual (e.g., graphic, text), flavor, or aroma component that provides contextual meaning to the image that goes beyond the visual appearance of the image itself. For instance, the interactive component can provide means, such as information or tools, to understand or view the image; alternatively, the interactive component can provide information to support or complement the image or to make a whole. The interactive component thus serves to enhance the value of the image to the consumer.

The interactive component can be delivered by any suitable means such as, but not limited to, printed text or graphics found on a container, a package, a package insert, a non-edible consumer good, printed media (e.g., printed advertisement), a billboard, another edible substrate, or any other suitable means such as internet (e.g., website), on-line communication, television, radio, or oral communication. The interactive component can be printed material attached directly or indirectly to a container that contains the edible substrate.

In one embodiment, the interactive component is not part of the edible substrate that comprises the image. In another embodiment, the interactive component is part of the edible substrate that comprises the image. In yet another embodiment, the interactive component is found on another edible substrate.

As used herein, “consumer” includes any purchaser, potential purchaser, user, or potential user of the article of commerce.

The message links the image to the interactive component. As used herein, “links” means communicates that the image and the interactive component are related or associated in some way. By linking the image to the interactive component, the value of the image is enhanced, thus giving it value beyond that value provided by the image alone. The message can inform the consumer that the image forms part of a whole with the interactive component, such that the image forms part of a story (e.g., where the interactive component provides a story-line having gaps to fill), that the image is a clue to be used in solving a mystery (e.g., where the interactive component provides a mystery game), that the image forms part of a game or instructions for a game (e.g., where the interactive component provides the game or parts of the game), the image comprises a clue for a video game (e.g., where the video game is the interactive component), the image comprises a game piece, information, or clue for a contest (e.g., where the contest is the interactive component), the image comprises part of an event, part of a joke, riddle, or revelation, that the image is part of a puzzle or is a puzzle piece, that using the image in some manner can lead to a reward or prize (e.g., find the chip printed with a bicycle and win the bicycle), can fill in the gaps of a storyline, can be used to solve a mystery, or can be used as part of a sequence of events (e.g., a series of commands, an animation).

The “message associated with said image” or the “message” informs the consumer that the image is linked to the interactive component.

The message can be a communication delivered by any suitable media, such as, but not limited to, printed text or graphics found on a container, a package, a package insert, a non-edible consumer good, a printed advertisement, a billboard, another edible substrate, or any other suitable means of communication such as internet (e.g., website), on-line communication, television, radio, or oral communication. As used herein, “graphics” can include a series of graphics, such as television or video game program displays.

The message can be printed material attached directly or indirectly to a container that contains the edible substrate, attached directly or indirectly near a container that contains the edible substrate, or alternatively can be a printed, electronic, or broadcast message associated with the image or edible substrate.

In one embodiment, an edible substrate is printed with the graphic of an adult female elephant. Another edible substrate is printed with the graphic of a baby elephant. A message on the container that contains the edible substrates has a message printed thereon which directs the consumer to match the mother animal with her baby.

In one embodiment, a plurality of edible substrates (e.g., fabricated chips) is printed with a variety of playing card images. The edible substrates are contained in a container. The container has a message printed thereon which directs the consumer to play a game (e.g., Old Maid, Crazy Eights, Blackjack, Poker) with the “cards.”

In another embodiment, a plurality of edible substrates are printed with caricatures of different popular athletes. Another plurality of edible substrates are printed with items used to play the sports of such popular athletes (e.g., soccer ball, baseball, hockey puck, basketball). The edible substrates are packaged in a container for sale to consumers. Printed on the package is a message that instructs the consumer to match the athlete with his sport. A key is also provided on the package, showing the correct match of athletes to sports items.

In conjunction with the image, the interactive component can be educational, entertaining, fun, mentally stimulating, informative, or otherwise engaging.

In preferred embodiment, the message can be found in, on, or near another consumer product (e.g., salsa canister, package of toothpaste) whether edible or non-edible, another edible substrate (e.g., can be contained within the same or a different container), found in the package or insert, publication (e.g., magazine, newspaper, broadcast advertisement, bill-board advertisement), website, or TV/Radio/Media.

The message informs the consumer that the image is associated with an interactive component. Suitable messages can include, but are not limited to, messages that direct the consumer to engage with the image for entertainment purposes (e.g., use the substrate in playing a game), educational purposes (“use the edible substrate), or as part of a sequence of events (e.g., in a story or a game),

In one embodiment, the message directs the user to use the substrate as part of a sequence of events. For example, a sequence of events can comprise two steps, wherein the first step comprises the image in the form of a question, and the second step comprises the answer which is found at a source other than the edible substrate.

In another embodiment, the interactive component conveys a mystery, and the message directs the consumer to solve the mystery by analyzing one or more clues found on one or more edible substrates (use the images found on the edible substrates as clues). Solving the mystery can be a single or multi-step process.

In another embodiment, the image provides both the mystery and the clue. The interactive component provides the answer to the mystery (e.g., provides a “key”). The message directs the consumer to solve the mystery by analyzing the image. In one such embodiment, the image provides an incomplete drawing of an object. The message directs the consumer to guess what the object is. The interactive component provides the answer (the key).

For example, FIG. 6 depicts a fabricated snack chip (20) (edible substrate) having an image of an incomplete house (21) disposed thereon, and a package insert (22) (interactive component) having a pictorial representation of the complete house (23). A message on the package that contains the edible substrate directs the consumer to guess what the object (the house) is and to refer to the package insert (22) (interactive component) for the answer (23).

In another embodiment, a plurality of edible substrates are printed with various facts about a particular topic (e.g., animal, science, nature, geography, math). The edible substrates are packaged together in a container. An image related to the topic is printed on the outside of the container. A message on the container informs the consumer that they can learn more about the topic pictured on the container by reading the facts that are printed on the substrates within the container.

In another embodiment, a plurality of edible substrates are printed with various facts about a particular animal. The edible substrates are packaged together in a container. A picture of the animal is printed on the outside of the container. A message on the container informs the consumer that they can learn more about the animal pictured on the container by reading the facts that are printed on the substrates within the container.

In another embodiment, the image is used to create a story line, to fill gaps in a story line, or to direct the flow of a story line. (e.g., offer a booklet with the story) The story can be solved or enjoyed by one or multiple consumers.

As used herein, “tactile components” include physical objects. In one embodiment, the interactive component is a tactile component in the form of 3-dimensional (“3-D”) glasses. When the consumer views the edible substrate while wearing the 3-D glasses, the image printed on the substrate has a 3-dimensional appearance. A message printed on the 3-D glasses instructs the consumer to wear the glasses to see the image in 3-D.

In one embodiment, a container comprises a plurality of edible substrates, wherein at least two edible substrates have images disposed thereon. At least two of the edible substrates have images that relate to different activities.

In another embodiment, a container comprises a plurality of edible substrates, wherein more than one image in said container relates to the same interactive component. (e.g., at least two the same)

In another embodiment, a container comprises a plurality of edible substrates, wherein at least one image relates to an interactive component. (e.g., at least one printed chip in the container)

In various embodiments, an event can lead to another sequence of events; small achievements can build to a bigger mystery; a sequence of events can be a story, a poem, a song, a game, a puzzle (e.g., hangman, checkers, chess, tic tac toe, a cryptogram). For example, a TV advertisement can provide information (interactive component) needed to solve a cryptogram (image) that is found on an edible substrate. The message can be found in one or multiple media, and can inform the consumer that the clues for solving the cryptogram can be found in a TV advertisement and/or in other media.

The meaning of images can remain static or can vary depending upon timeframe or interactive component delivery media. In one embodiment, a cryptogram (image) is provided on an edible substrate. The cryptogram comprises five symbols. Several different interactive components (e.g., delivered via TV, magazines, package label, and package insert) provide a key to decode the cryptogram, each of which can provide a different meaning to the same cryptogram. The message directs the user to use various interactive components for a given image.

D. Optionally a Container for Containing Said Edible Substrate

Optionally, the article of commerce comprises a container for containing said edible substrate. Any container from which the edible substrate can be dispensed, presented, displayed, or stored is suitable. Suitable containers include, but are not limited to, bags, canisters, boxes, bowls, plates, tubs, and cans. In one embodiment, the container is a round cylindrical canister that can contain fabricated potato crisps.

### EXAMPLES

The following examples are illustrative of the present invention but are not meant to be limiting thereof.

### Examples 1-10

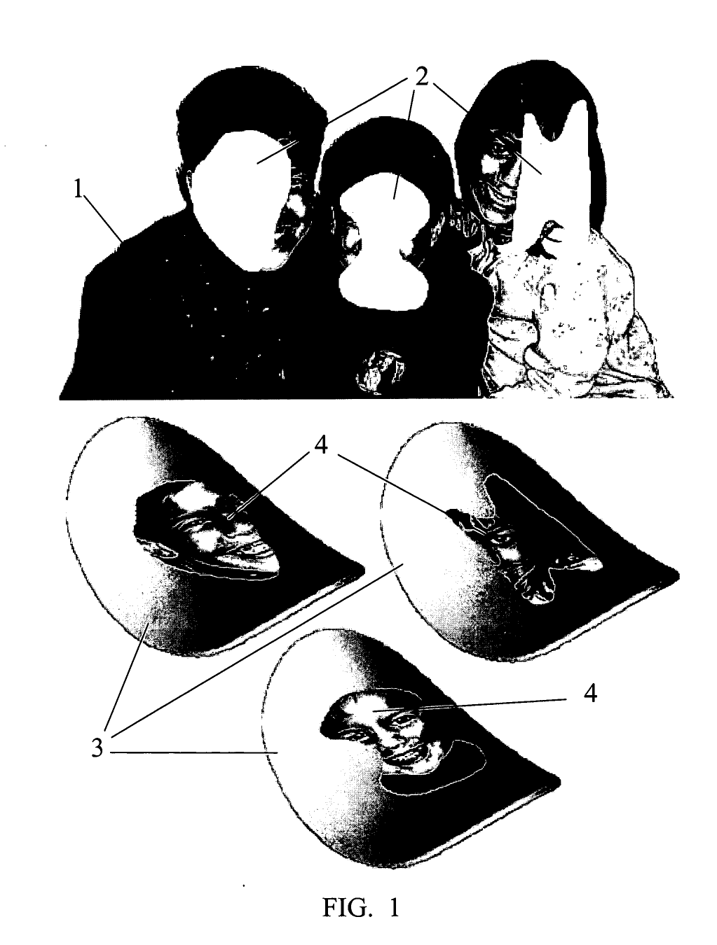

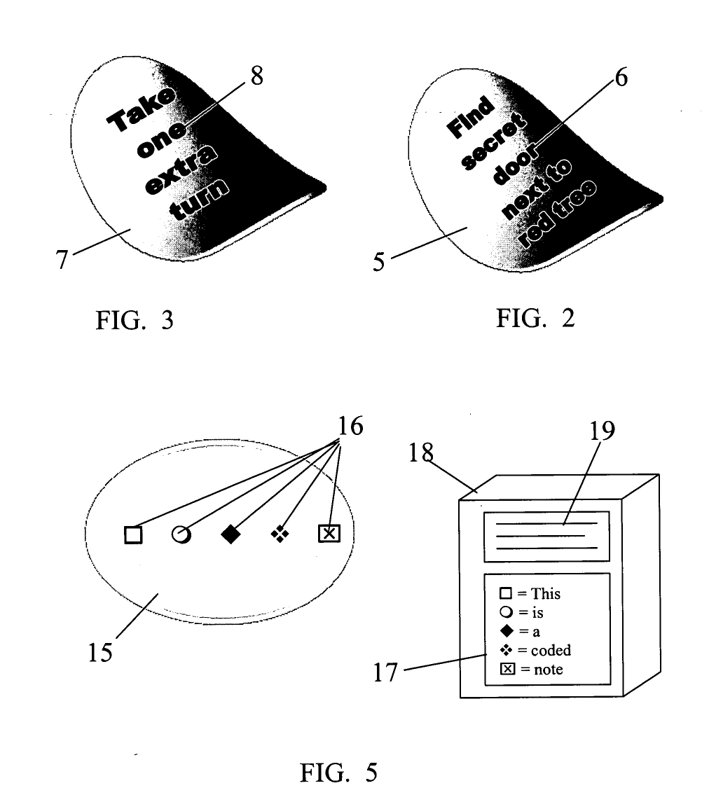

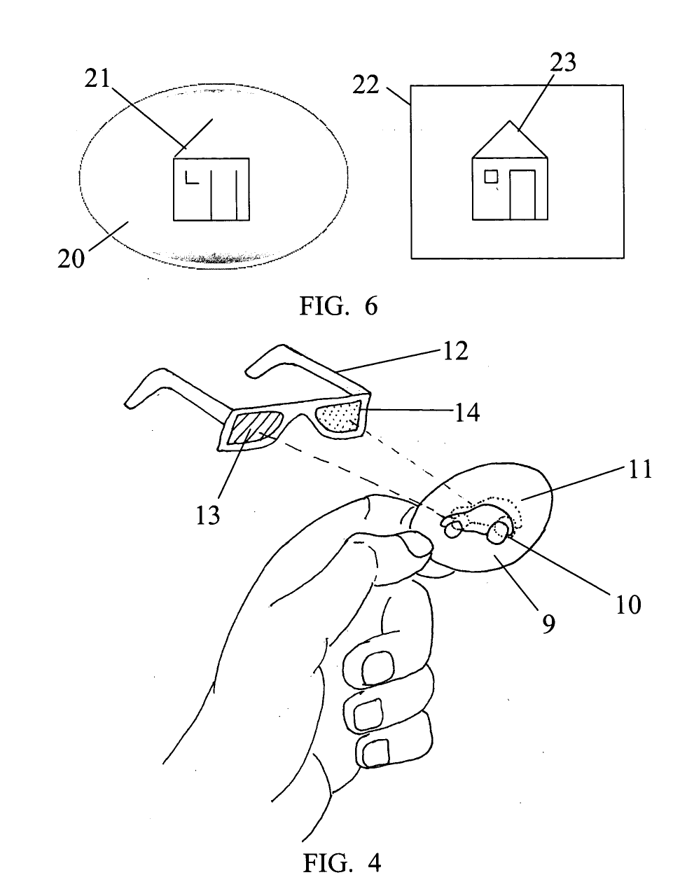

The examples below illustrate the article of commerce comprising an edible substrate, an image disposed on the edible substrate, an interactive component, and a message linking the image and the interactive component:

| | Edible | | Interactive | | |
|---|---|---|---|---|---|
| Ex # | Substrate | Image | Component | Message | Comments |
| 1 | Potato | Question | One or more | Instruction | Reverse can also be true, |
| | chip | | answers available | printed on | where chips holds answers |
| | | | in package label, | package label | and questions are provided |
| | | | package insert or | direct | as part of the interactive |
| | | | attachment, a | consumer to | component. |
| | | | separate | match | |
| | | | publication, | questions | |
| | | | website, TV, radio, | printed on | |
| | | | advertisement or | chips with | |
| | | | other. | answers at | |
| | | | (**) | specified | |
| | | | | location. | |
| 2 | Potato | Question | Another crisp with | Instructions | Questions may have |
| | crisp | | printed answer. | attached on | multiple possible answers, |
| | | | (**) | package label | and answers may be |
| | | | | direct | applicable to multiple |
| | | | | consumers to | questions, making it fun |
| | | | | match | and interactive. |
| | | | | questions and | |
| | | | | answers | |
| | | | | printed on | |
| | | | | chips. | |
| 3 | Tortilla | Visual | Mystery challenge | Directs | Multiple edible substrates |
| | chip | and/or text | or riddle provided | consumers to | may comprise images |
| | | clue | in package label, | solve mystery, | containing clues to help |
| | | | package insert or | riddle or | solve more than one |
| | | | attachment, a | puzzle by | mystery. Clues could be |
| | | | separate | using clues | identified as being related |
| | | | publication, | provided on | to a particular mystery to |
| | | | website, TV, radio, | chips | help consumers sort out |
| | | | advertisement or | | which clues apply to which |
| | | | other means. | | mystery. Solving the |
| | | | (*), (**) | | mystery can lead to a |
| | | | | | reward like a joke, a |
| | | | | | revelation, a discount, or a |
| | | | | | prize. |
| 4 | Potato | Graphic | Board (1) of FIG. 1 | Directs | May use as collectibles or |
| | Crisps | and/or text | with holes (2) | consumers to | use as part of a marketing |
| | (3) of | (4) of FIG. 1 | under which crisps | use crisps in | campaign where a prize |
| | | | (3) may be placed | combination | may be awarded to the first |
| | | | to reveal a larger | with board to | to unravel the image. |
| | | | image. | reveal image. | |
| | | | (*), (**) | | |
| 5 | First | Character | Second chip with | Directs | Interactive component may |
| | Chip | | same character | consumers to | include more than one |
| | | | image and third | find which | component. |
| | | | chip with a slight | image is | |
| | | | modification of | different. | |
| | | | character image in | | |
| | | | first and second | | |
| | | | chip. | | |
| | | | (**) | | |
| 6 | Cracker | Character | Label includes | Directs | Multiple crackers in a |
| | | | image of character. | consumers to | container can carry |
| | | | This image may | determine if | multiple (different) |
| | | | change over time | the image on | versions of the image of the |
| | | | from one label to | chip matches | character, one version of |
| | | | another. | image on | which can match image on |
| | | | (**) | label. | label, while the others |
| | | | | | include major or minor |
| | | | | | modifications |
| 7 | Potato | Video game | Video game | Indicates to | Advertising media can say |
| | crisp (5) | tip in visual | (**) | consumer that | something to the effect that |
| | of | and/or text | | such tip(s) | “make sure to have your |
| | | form (6) of | | applies to a | potato crisps ready when |
| | | | | specific video | you play the video game” |
| | | | | game, to | |
| | | | | better perform | |
| | | | | during the | |
| | | | | playing. | |
| 8 | Potato | Instructions | Board game | Indicates to | As an example, the image |
| | crisp (7) | (8) of FIG. 3, | (**) | consumer that | can say: “Take one extra |
| | of | play | | image may | turn” |
| | | money or | | provide them | |
| | | other board | | with an | |
| | | game | | advantage | |
| | | related. | | while playing | |
| | | | | a specific | |
| | | | | game. | |
| 9 | Tortilla | Combined | 3-Dimensional | Directs | Colors can be other than |
| | chip (9) | blue (10) | glasses (12) of | consumers to | red and blue. The lid of a |
| | of | and red (11) | FIG. 4, with one | use 3D glasses | canister can become the 3D |
| | | images of | lens (13) filtering | to view | glasses or part of it. The |
| | | FIG. 4. | red that allows to | images on | glasses help to understand |
| | | | see blue image | chip in 3- | the image. |
| | | | (10), and another | dimmensions. | |
| | | | lens (14) filtering | | |
| | | | blue that allows to | | |
| | | | see red image (11). | | |
| | | | (*), (**) | | |
| 10 | Potato | Coded | Decoding means | Message (19) | The coded message can be |
| | crisp | message | (17) of FIG. 5 | of FIG. 5 | formed with symbols each |
| | (15) of | (16) of | attached to | directs | representing, for example, a |
| | | | container (18). | consumers to | letter, a word, or number. |
| | | | (*), (**) | “Use decoding | Alternatively, the coded |
| | | | | means to | message may be formed |
| | | | | understand | with invisible ink, which is |
| | | | | coded | made visible with special |
| | | | | message” (16) | glasses or with other means |
| | | | | | such as, for example, heat, |
| | | | | | pH change, or chemical |
| | | | | | reaction, such as through |
| | | | | | contact with saliva or |
| | | | | | exposure to light. The |
| | | | | | decoding means help to |
| | | | | | understand the image. |

Interactive Component:
*Provides means, like information or tools, to understand or view image; or
**Provides information to support or complement image, to make a whole; a context within which the image has meaning.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An article of commerce comprising:
(a) an edible substrate;
(b) an image disposed upon said edible substrate;
(c) a message associated with said image, wherein said message links the image to an interactive component; and
(d) optionally a container for containing said edible substrate.

2. The article of claim 1, wherein said interactive component is not part of the edible substrate that comprises the image.

3. The article of claim 1, wherein said edible substrate is selected from the group consisting of snack chips, potato chips, potato crisps, tortilla chips, extruded snacks, crackers, cookies, cakes, cup cakes, bread, breakfast cereals, toaster pastries, ice cream cones, waffles, pancakes, English muffins, pizzas, ice cream sandwiches, pies, chewing gum, candy, fruit, dried fruit, dried fruit film, beef jerky, hot dogs, sliced meats, cheese, meat patties, fish sticks, ice cream, gelatin, ice pops, yogurt, desserts, and cheese cake.

4. The article of claim 1, wherein said image is printed on said edible substrate with an ink jet printer.

5. The article of claim 1, wherein said interactive component comprises a tactile component, audio component, visual component, flavor component, aroma component, or combination thereof.

6. The article of claim 1, wherein said article comprises:
(a) a plurality of edible substrates;
(b) at least two different images disposed upon at least two different edible substrates;
(c) a message associated with at least one image, wherein said message links the at least one image to an interactive component; and
(d) optionally a container for containing said plurality of edible substrates.

7. The article of claim 1, wherein said image and said interactive component are components of the same puzzle or the same game.

8. The article of claim 1, wherein said interactive component comprises a means to view the image.

9. The article of claim 1, wherein said message comprises printed text, printed graphics, audio communication, visual communication, or a combination thereof, and further wherein said message is communicated by a container, a package, a package insert, a non-edible consumer good, a printed advertisement, a billboard, another edible substrate, the internet, on-line communication, television, radio, oral communication, or a combination thereof.

10. An article of commerce comprising:
(a) a plurality of fabricated snack chips;
(b) an image disposed upon at least one fabricated snack chip;
(c) a message associated with said image, wherein said message links the image to an interactive component; and
(d) a container for containing said plurality of fabricated snack chips.

11. The article of claim 10, wherein said image is printed on said edible substrate with an ink jet printer.

12. The article of claim 10, wherein said interactive component comprises a tactile component, audio component, visual component, flavor component, aroma component, or combination thereof.

13. The article of claim 10, wherein at least two different images are disposed upon at least two different fabricated snack chips.

14. The article of claim 13, wherein each of the images disposed upon each fabricated snack chip is different from the other images disposed upon the other fabricated snack chips.

15. The article of claim 14, wherein each of the fabricated snack chips has an image disposed thereon.

16. The article of claim 14, wherein said article comprises at least 10 fabricated snack chips.

17. The article of claim 10, wherein said image comprises more than one color.

18. The article of claim 10, wherein said image and said interactive component are components of the same puzzle or the same game.

19. The article of claim 10, wherein said interactive component comprises a means to view the image.

20. The article of claim 10, wherein said message comprises printed text, printed graphics, audio communication, visual communication, or a combination thereof, and further wherein said message is communicated by a container, a package, a package insert, a non-edible consumer good, a printed advertisement, a billboard, another edible substrate, the internet, on-line communication, television, radio, oral communication, or a combination thereof.

21. The article of claim 10, wherein said interactive component is not part of the fabricated snack chip that comprises the image.
